(19) United States
(12) Patent Application Publication
(10) Pub. No.: US 2024/0280600 A1
(43) Pub. Date: Aug. 22, 2024

(54) Integrated Sample Preparation and Analysis System

(71) Applicant: Disruptive Laboratory Innovations, LLC, North Wales, PA (US)

(72) Inventor: Bingfang Yue, North Wales, PA (US)

(73) Assignee: Disruptive Laboratory Innovations, LLC, North Wales, PA (US)

(21) Appl. No.: 18/292,193

(22) PCT Filed: Aug. 1, 2022
(86) PCT No.: PCT/US2022/038997

§ 371 Date: Jan. 25, 2024

(51) Int. Cl. G01N 35/00; G01N 35/02; G01N 35/10

(52) U.S. Cl. CPC G01N 35/0099; G01N 35/025; G01N 35/1002

(57) ABSTRACT

According to the invention, a robotic arm is used to transport a separation device integrated with a liquid handling system that uses a single probe or disposable pipette tip for liquid handling purposes. A biological fluid sample and necessary reagents are transferred into a separation device by the liquid handling system under metrological control. Thereafter, the content in the separation device is exposed to ultrasonic power to achieve homogeneity and accelerate protein denaturization or molecular interaction. Then, a clean sample extract with complete removal of unwanted proteins and other impurities is obtained by filtration and is loaded into a sample loop and injected for analysis by a binary pump system with various types of chromatographic detectors, for example, a mass spectrometer.

### CROSS REFERENCE TO RELATED APPLICATIONS

This application is the US national phase application of PCT/US2022/038997 filed Aug. 1, 2022 and which claims benefit of and priority to U.S. Provisional Patent Application No. 62/228,177, filed Aug. 2, 2021, where permissible incorporated by reference in its entirety.

### TECHNICAL FIELD

The invention generally relates to the field of liquid chromatography analysis of samples of biological origin, and more specifically, a random-access system which automatically prepares and analyzes such samples according to a variety of different assays.

### BACKGROUND OF THE INVENTION

Liquid chromatography (LC)-mass spectrometry (MS) technology has been increasingly adopted in clinical diagnostic laboratories alongside with its broad acceptance in biomedical research and pharmaceutical industry due to many advantages afforded by the technology, including high analytical specificity and sensitivity, multiplexing capacity to analyze many target compounds in one assay, much lower assay development cost compared to immunoassay, no limitations of immunoassay (e.g. non-specific binding and cross reactivity).

Nevertheless, the global prevalence of LC-MS technology in clinical diagnostics is low with probably far less than one percent of diagnostic analysis performed with LC-MS worldwide. LC-MS is still limited to specialty laboratories and many challenges that prevent it from being implemented routinely in typical clinical laboratories. The overall workflow is labor intensive and manual process-driven; it requires highly trained technical staff to perform daily operations and assay development; limited access to those expertise and extensive technical training requirements have hindered the growth and implementation of this platform; the throughput is lower than fully automated chemistry or immunoassay analyzers, which provides less desirable productivity and turnaround time for many clinical applications.

To date, LC-MS instrumentation is still designed to be utilized in research settings with specialized technical personnel available. Furthermore, despite the fact that sample preparation procedures have a dramatic impact on assay throughput, assay performance and overall cost, sample preparation that is used to enrich or isolate the analytes of interest from complex biological matrix, has not been integrated into LC-MS instrumentation that has been close to be fully automated. Lack of a fully automated platform combining LC-MS and sample preparation makes it impractical, both technically and financially, for most clinical laboratories to adopt LC-MS technology for routine clinical use. Instead, these clinical laboratories generally use alternative diagnostic techniques such as automated immunoassay that is less specific or send samples to a specialty laboratory that has adopted LC-MS technology.

Sending samples to a specialty laboratory for analysis has many drawbacks including high cost, long turnaround time and problematic sample stability. At each such specialty laboratory, samples of one specific assay are generally grouped into large batches and processed serially to be practical and to increase productivity, with each batch including multiple calibrators and quality controls. In contrast, for a typical clinical laboratory, the number of samples of one specific assay is often too low for the batch approach to be cost-effective, for example, a batch including one sample, seven calibrators and seven quality controls. Thus, a fully automated platform capable of random access, meaning that hardware can be automatically reconfigured by software without manual human intervention to perform different assays on a sample, without calibrator set and with minimum number of quality controls, is mandatory so that the total number of samples of different assays from a typical clinical laboratory as well as minimum instrument downtime can justify the adoption of such a platform financially.

Therefore, there is a need for fully automated sample preparation system that can process a variety of different biological matrices for a variety of different assays. Further, there is a need for fully automated and integrated sample preparation and analysis system, that can be easily handled by a typical clinical laboratory while performing a variety of different assays. There is yet also a need for a sample preparation and analysis system that provides robust random access for a variety of different assays on a single system.

### BRIEF SUMMARY

According to the invention, a robotic arm used to transport a separation device is integrated with a liquid handling system that may use a single probe or disposable pipette tip for liquid handling purpose. A biological fluid sample and necessary reagents are transferred into a separation device by liquid handling system under metrological control. Thereafter, the content in the separation device is exposed to ultrasonic power to achieve homogeneity and accelerate protein denaturization or molecular interaction. Then, a clean sample extract with complete removal of unwanted proteins and other impurities is obtained by filtration and is loaded into a sample loop and injected for analysis by a binary pump system with various types of chromatographic detectors, for example, a mass spectrometer.

One embodiment of the invention preferably includes: a dispensation port on a metrological control device for setting a separation device, into which a biological sample or a reagent is dispensed and its weight is recorded; a mixing port which applies ultrasonic power to the separation device so that sufficient mixing occurs; an injection port through which the separation device is coupled to an injection system that consists of a syringe pump and an injection valve; a 2-position 4-port valve used to select one of a typical binary mobile phases to flow through the sample loop; a static mixing device to combine and mix the two mobile phase flow before entering an analytical column that is used to retain and separate the target components from other components originated from the biological sample; liquid delivering pump with solvent selection valve to access various types of mobile phases; column selection valve to access multiple analytical columns; another 2-position 4-port valve to choose flow direction through analytical column.

One embodiment of the invention preferably also includes a control system comprising a computer storage medium and a data processor, which 1) is electrically or operatively coupled to and stores all parameters and settings of all processing units described above, 2) automatically verifies a preparation item and an analysis item, which contain data associated with a testing order submitted by an analyst and specifying a predefined assay to be performed on a particular biological sample, against stored parameters and settings, 3) automatically reconfigures and prepares all processing units if necessary according to the preparation and analysis items, 4) automatically executes the preparation and analysis items, and acquires signal data, 5) automatically performs data analysis to obtain one or a plurality of measurement values.

### BRIEF DESCRIPTION OF THE DRAWINGS

FIG. 1 is a cross-sectional view showing an example of a separation device.

FIG. 2 shows a simplified structure of a holding part for holding and transporting a separation device.

FIG. 3 is a cross-sectional view showing an example of a dispensation port on top of a metrological control device.

FIG. 4 is a cross-sectional view showing an example of a mixing device by ultrasonic power.

FIG. 5 is a cross-sectional view showing an example of an injection port.

FIG. 6 is a fluidic system configuration diagram showing flow paths of a sample analysis apparatus in the embodiment.

FIG. 7 is a block diagram illustrating a control system of the embodiment

FIG. 8 is a flowchart illustrating a series of processing operations performed for one sample of the embodiment

FIG. 9A is a schematic view of a solvent selection valve

FIG. 9B is a schematic view of a quaternary pump

FIG. 10 is a schematic view of column selection setup

FIG. 11 is a schematic view of column selection setup that can reverse flow direction through analytical column

### DETAILED DESCRIPTION OF THE INVENTION

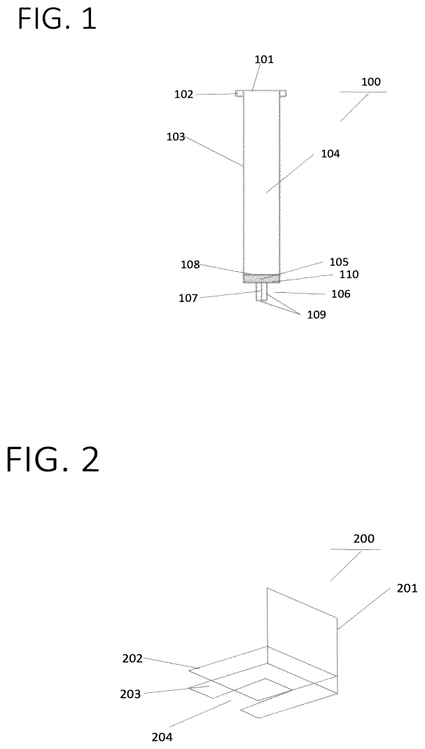

An exemplary separation device 100 is depicted in FIG. 1. As shown, a separation device 100 is a unitary construction with a cylindrical section 103, a flange part 102 on top and a slip connection section 106 at lower end, all made of same material. As shown, a separation device has a round first end 101 that is open. A sample for preparation and analysis can be inserted through the round first end 101 into the interior space 104 of the cylindrical section 103. The flange part 102 is a circumferential expansion of an outer circumferential surface of the cylindrical section 103 on top end. The flange part 102 makes it easy to hold the separation device 100 so that a configuration of a holding part of a robotic arm which carries the separation device can be simplified (described later).

The slip connection section 106 is a structure like a male Luer-type slip with a center flow passage between the round second end 110 and the bottom surface 109 of the slip connection section 106. A processing means included in a controller is configured to press the separation device 100 downward with a holding part of a robotic arm after connecting the separation device 100 into an injection port (described later). Thus, the surface 109 of the slip connection section 106 intimately mates with the receiving opening of an injection port and forms a liquid-tight Luer-type connection.

A separation layer 105 is provided at the bottom of the cylindrical section 103 in the separation device 100. The separation layer is at least a filter for removing denatured protein or particulate material originated from a sample. The pore size of the filter layer depends on sample types designated for preparation and analysis. The filter can also be multiple layers, for example, a prefilter layer with larger pore size that is more resistive to clogging above a layer of smaller pore size, a sorbent layer placed between two filter layer that can be utilized to remove additional undesired components from a sample besides denatured proteins. It is also possible to have loose unpacked sorbent on top of the filter layer. The filter and sorbent can be made of various material such as polymer, metal, silica, glass and the like. Simply, a separation device can be any syringe-format cartridge used for chromatography, solid phase extraction, protein precipitation or lipid removal. Moreover, a separation device can be a construct of any like shape, such as a modified pipette tip, with a top opening to receive a sample or a reagent, a separation layer held at bottom above a conduit that can form a tight liquid connection with an injection port, as described above.

One or more reagents may be added into a separation device for different purposes. A reagent may contain internal standard for quantitative analysis, lysis buffer to lyse cells, enzyme for digestion of protein or peptide, enzyme for hydrolysis of analyte in conjugated forms, organic solvent or chaotropic agent to denature proteins, acid, base or buffer salt to adjust pH, besides water content.

As referenced above, a holding part of a robotic arm as a part of a carrying mechanism is needed to transport and operate the separation device from different locations. A carrying mechanism may include a robot assembly operating on one or more tracks and configured to move in at least one linear or rotary directions and which may include an automated liquid handling assembly. One example and preferably, an x-y-z robotic arm is configured to move freely in three independent directions to any position and carries the holding part or a liquid handling assembly such as a sampling device to perform any predefined task, such as transporting the separation device or aspirating and dispensing a sample.

Another example of a carrying mechanism is a robotic arm which horizontally extends and holds the holding part or a liquid handling device (tool) on the extending end in downward direction, has a base end pivotally supported by a shaft extending vertically, is configured to rotate about the shaft in a horizontal plane, and vertically move up or down along the shaft. In such a case, any predetermined position to be accessed by any tool carried by the carrying mechanism is located along a circumferential track which is made by the carried tool along with the rotation of the robotic arm. As a result of the above-described configuration, it is necessary to have another transport mechanism to transfer a separation device from another location to a designated position for the carrying mechanism.

There are many possible combinations in which multiple linear or rotary positioning devices are used to construct a robotic arm. The two examples above are commonly seen with automated chemistry or immunoassay analyzer for in vitro diagnostics and autosampler (autoinjector) for chromatography instrumentation.

A liquid handling assembly may include a sampling device that is movable, for example via a carrying mechanism, in one or more of the x-y-z directions and between two or more of sample or reagent location or processing ports. The sampling device may be built with a single probe construction that is washed between aspirations at a wash station or, alternatively may be adapted to receive a disposable tip that is then ejected before acquiring a new disposable tip to aspirate a different sample or reagent. In the former embodiment, after a sample is dispensed to a separation device, the single probe is washed, one or more times, by an appropriate solvent solution, such as by multiple aspirations and dispensing of the solvent. In the latter embodiment, after the sample is dispensed to a separation device, the disposable tip is ejected from the sampling device into a disposable tip waste chute.

A sampling device has a sampling nozzle for taking a sample from a sample container set in the sample setting location, preferably organized by sample racks. A sampling nozzle is held on a tip side of the sampling device in such a manner that the sampling nozzle is oriented vertically downward and is moved up or down in a vertical direction by a robotic arm. The carrying mechanism moves the sampling device to the desired sample position and moves the sampling device downward until the sampling nozzle goes under the liquid level inside the sample container and takes a sample.

As described above, a robotic arm as part of a carrying mechanism and a liquid handling assembly including a sampling device are integral and essential components to complete the integrated sample preparation and analysis system of the invention but are not the essential novelty of the invention as one of ordinary skill in the art will readily recognize that incorporation of such devices into such a system is a necessity and easy to obtain with their broad commercial availability.

An exemplary holding part 200 of a robotic arm forming a carrying mechanism is mentioned above and depicted in FIG. 2. As shown, the holding part consists of three components, an adapter 201 to connect with a robotic arm, a top piece 202 and a bottom piece 203. The vertical space between the top piece 202 and the bottom piece 203 allows the flange part of a separation device slide in and out freely and snug tightly enough at the same time. The opening 204 in the center of the bottom piece 203 allows the cylindrical section 104 of a separation device slide in and out freely and snug tightly enough at the same time. The thickness of the bottom piece 203 is large enough in vertical direction so that the separation device is held upright and tightly in place. The holding part is constructed with sufficient physical strength to allow physical forces to be applied to a separation device against an injection port in vertical direction by the robot arm that carries the holding part that holds the separation device.

In order for a holding part 200 to engage a separation device 100, the separation device 100 needs to be placed in a stationary holding position, such as sitting vertically in a rack with the flange part 102 pointing upwards. The robotic arm with the holding part 200 connected comes down from a higher position to a side of a separation device 100 at a proper level related to the flange part 102 of the separation device in such a way that when the robotic arm keeps moving horizontally towards the separation device, the flange part 102 and the cylindrical section 103 below the flange part of the separation device slides through and snugs fit into the vertical space between the top piece 202 and the bottom piece 203 and the horizontal opening 204 of the holding part, respectively. Afterwards, the robotic arm can move up and lift the separation device out of current holding position such as a rack. In reverse operation, a separation device can be positioned and disengaged from a holding part into a new holding position.

A better option to a holding part is a robotic gripper that can activate electrically or pneumatically to open or close so that the gripper can catch or release a separation device under computerized control. It is obvious that a robotic gripper carries higher cost compared to a holding part as described.

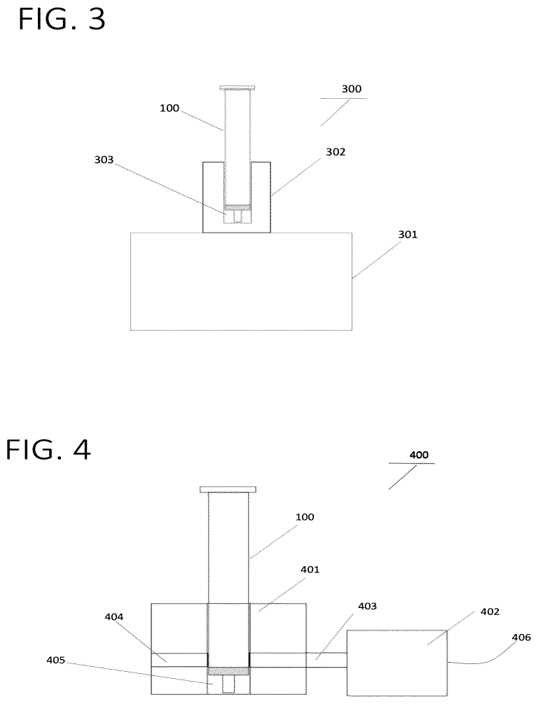

Next, a robotic arm with a holding part 200 can transport a separation device 100 to a metrological control device 300 depicted in FIG. 3, such as an analytical or precision balance that is capable of accurate measurement of 1, 0.1 or 0.01 milligram. The metrological control device 300 is composed of a measurement system 301 and a modified load receptor used as a dispensation port 302. The dispensation port 302 is in place of a load receptor of an analytical balance, stands upright and has a receiving bore hole 303 in the center as shown. The inner diameter and depth of the bore hole, and the outer diameter of the central cylindrical part of a separation device are such that a separation device fits well in the bore hole, and stands upright by itself, can be moved up and down, that is in and out of the bore hole freely. With an unused separation device installed on the metrological control device 300, a sample or a reagent can be delivered into the separation device by the sampling device of a liquid handling assembly described above.

Herein, the weight of a separation device, a sample or a reagent is recorded once at a time when delivered to the metrological control device. By recoding the weight of a sample or a reagent and comparing it to the designated volume that is targeted and known density information of a sample or a reagent, the accuracy and precision of the liquid handling assembly can be metrologically controlled. Thus, the signal ratio of an analyte of interest in a sample and an internal standard, stable isotope labelled internal standard preferably for mass spectrometric detection, in a reagent, can be used directly to quantitate the analyte without an external calibration curve, since quantity, recovery and signal response of analyte and internal standard can be tightly controlled by the fully automated system according to the invention.

After a sample and necessary reagent are added into a separation device 100 placed in the dispensation port 302 of a metrological control device 300, a robotic arm with a holding part 200 can then transport the separation device 100 from the metrological control device 300 to a mixing apparatus 400 depicted in FIG. 4. Similar to a dispensation port, a mixing apparatus 400 stands upright and has a vertical through receiving bore hole 405 in the center of the block 401 as shown. An ultrasonic device including a converter/probe assembly 403 and a power supply 406, is positioned on one side of the block 401 in such a way that the probe 402 of the converter/probe assembly 403 passes through a side hole in the block 401 with the tip of the probe 402 intimately contacts and presses against a separation device placed in the vertical bore hole 405. Vertically, the probe 402 is positioned above the separation layer of the separation device so that solution mixture above the separation layer can be mixed well with ultrasonic energy

The amount of ultrasonic power that an ultrasonic power supply delivers is dependent on the amount of resistance that the tip of the probe encounters. The greater the resistance, the greater the amount of power that will be delivered by the power supply. In this case, the tip of a vibrating probe 403 is made to contact a separation device 100 containing a, the more forceful the contact, the greater the amount of energy that will be delivered into the liquid. In order to ensure consistent and repeatable transfer of energy into the liquid, a spring-loaded set screw with a ball end is installed in a threaded hole 404 that is aligned opposite to the hole for the probe 403 of the ultrasonic converter/probe assembly 402. In such a way, the ball screw from one side and the ultrasonic probe 403 from the opposite side press against a separation device with the applied force that is adjustable by setting the ball screw accordingly.

A mixing apparatus 400 can be position above an injection port (described next) and aligned properly so that a separation device can be pushed down further to connect with the receiving opening of the injection port. Other embodiments of a mixing apparatus can be a shaker, a vortex mixer or the like. A mixing apparatus using ultrasonic power is preferred due to simple system design and high mixing efficiency.

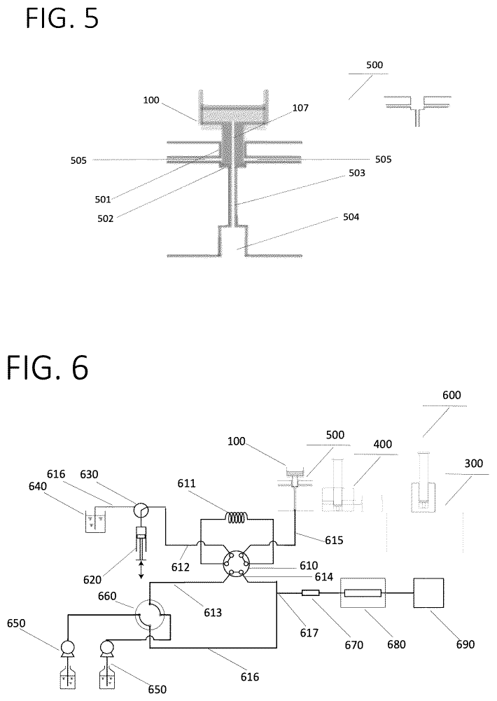

Next, a separation device 100 processed by a mixing apparatus 400 can be transported by a holding part 200 of a robotic arm and connected with an injection port 500, that is depicted in FIG. 5, by pressing the separation device 100 downward so that the slip connection section 106 of the separation device slips into the receiving opening of the injection port formed by wall 501 and bottom 502 and forms a liquid-tight Luer-type connection that connects conduit 107 in the slip connection section 106 of a separation device to a conduit 503 below the receiving opening and then to a female fitting detail 504 such as a 10-32 or a ¼-28 fitting. The total volume of conduit 107 and 503 should be as small as possible. In the wall 501 and above the bottom 502 of the receiving opening of the injection port, there are conduits 505 constructed in such a way that a liquid stream supplied from conduit 503 washes the receiving opening and flows into a waste container (not shown) through conducts 505 that acts as a waste line, while a separation device is not connected to the receiving opening.

One embodiment of a sample injection system according to the invention is described with reference to FIG. 6. A two-position six-port injection valve 610 is shown in FIG. 6 as an example. The respective ports of the injection valve are connected to a sample introduction flow path 615 from an injection port 500, a flow path 612 to a syringe pump 620, and one end and the other end of a sample loop 611 as well as an upstream analytical flow path 613 and a downstream analytical flow path 614. The injection valve 610 is configured in such a way that the injection valve 610 can switch between two states, either a state (1, Loading) where the sample introduction flow path 615, the sample loop 611 and the flow path 612 to the syringe pump 620 are connected in series, and the downstream analytical flow path 614 is connected immediately downstream of the upstream analytical flow path 613 (a state shown in FIG. 1), or a state (2, Injection) where the upstream analytical flow path 613, the sample loop 611, and the downstream analytical flow path 614 are connected in series, and the injection port 500 and the sample introduction flow path 615 are connected to the flow path 612 to the syringe pump 620.

In order to deliver a sample extract prepared in a separation device 100 for sample analysis, the injection valve 610 is operated so as to bring about a state (1) before the separation device will be transferred by a holding part 200 of a robotic arm and installed into the injection port 500 by pressing down the separation device into the receiving opening of the injection port. Once the separation device is fluidically connected, the syringe pump will withdraw so that the sample extract in the separation device will pass through the separation layer 105, through the conduit 107 of the separation device, the conduit 503 of the injection port and the sample introduction flow path 615, enter and be held inside the sample loop 611. Thereafter, the injection valve 610 is switched to bring about a state (2), so that the sample extract stationed inside the sample loop 610 is pushed out of the sample loop 611 to an analytical column by a mobile phase delivered from a liquid delivery apparatus for sample analysis (described later).

After sample analysis starts, the used separation device 100 will be disposed by the robotic arm into a solid waste disposal port (not shown). The syringe pump 620 can connect with a cleaning liquid container 640 in which a cleaning liquid is stored through a flow path 616, depending on switching of a flow path selection valve 630. By connecting the syringe pump 620 which is filled with a cleaning liquid with the injection valve 610 in state (1), through switching the flow path selection valve 630, and delivering the cleaning liquid through the flow path 612 between syringe pump 620 and the injection valve 610, the flow path inside the injection valve 610, the sample introduction flow path 615 and the conduit 503 in the injection port 500. The cleaning liquid eventually goes into the liquid waste container that is not shown in the drawings, through the waste line 505. By this way, all flow path for sample introduction can be rinsed. By the same way and with the injection valve in state (2), it is possible to wash the inner surface of the sample loop. By alternating the injection valve between state (1) and (2) multiple times, it is possible to wash any inner liquid contact surface inside the injection valve to eliminate any potential carryover. Moreover, a syringe pump 620 with a flow path selection valve 630 that has a plurality of ports, can withdraw from multiple liquid inputs or dispense to multiple liquid outputs. By using multiple different cleaning liquid (type of solvent, for example water, organic solvent, acid, base, salt and pH, volume and number or combination of washing cycle), sample injection free of carryover can be ensured.

One embodiment of a sample analysis apparatus according to the invention is also shown in FIG. 6. The sample analysis apparatus includes a liquid delivery apparatus 650, a two-position four-port switching valve 660 used to switch between two liquid sources, a tee connection 617 and an in-line mixing device 670, an analytical column 680 inside a column oven with temperature control, and a detector 690, in addition to a sample injection valve 610. The liquid delivery apparatus 650 is a liquid delivering pump, which delivers, for example, a liquid solution from a liquid source as a mobile phase. It is common for a sample analysis apparatus to use two liquid delivery pumps, one for high water content and another one for high organic content, such a system is usually referred to as a binary system. As shown, two liquid delivery pumps are connected to a two-position four-port switching valve 660, and the other two ports of the valve 660 are connected to an upstream analytical flow path 613 and a mobile phase flow path 616. In this way, only one mobile phase, either high water content or high organic content, can be switched to pass through the upstream analytical flow path 613 and then the injection valve 610, by switching the two-position four-port valve 660. It is designed to match the organic content of a mobile phase passing through a sample loop 611 that holds a sample extract with the organic, during sample loading, so that no components in the sample extract will become insoluble, thus may precipitate out of solution and clog the downstream flow paths. After sample loading, the valve 660 can be switched multiple times to alternate between high water content and high organic content to clean all flow paths with both high content of aqueous or organic solvent.

The two flow streams from a downstream analytical flow path 614 and a mobile phase flow path 616 are then combined through a tee connection 617 and mixed sufficiently by an in-line mixing device 670 before entering an analytical column 680. The tee connection 617 and the in-line mixing device 670 is positioned to provide sufficient mixing of one high organic flow and one high water flow and can be combined into one piece. The inline mixing device 670 may preferably be an inline filter provided that it provides sufficient mixing. Depending on the separation mechanism of the analytical column used, either high organic or high water content in the combined flow stream is preferred during sample loading in order to chromatographically focus the component of interest and preserve high separation efficiency of the analytical column.

In a binary system, the mobile phase composition is varied during the course of sample analysis, such as from an initial low organic to a final high organic content (same as an initial high water content to a final low water content), as referred to as gradient. The other types of gradients include pH and additives such as an acid, a base, a salt or any combination thereof. If the mobile phase composition is kept constant, it is referred to as isocratic. With either isocratic or gradient condition, the sample extract is separated into individual components in the analytical column according to each component's retentivity with the analytical column and the mobile phases used. The individual components separated in the analytical column are detected by a detector 690. The detector can be any type of detector used in a liquid chromatography system, such as a mass spectrometer, and can be multiple different detectors connected in series, such as an ultraviolet-visible absorption detector followed by a mass spectrometer, or an electroconductivity detector followed by a fraction collector that is not a detector.

A signal produced in the detector 690 is acquired and stored by a system management apparatus (not shown), and data processing for quantitative analysis or composition analysis of individual components separated in the analytical column 680 is performed by a software installed in the system management apparatus and hardware such as a personal computer which executes the software.

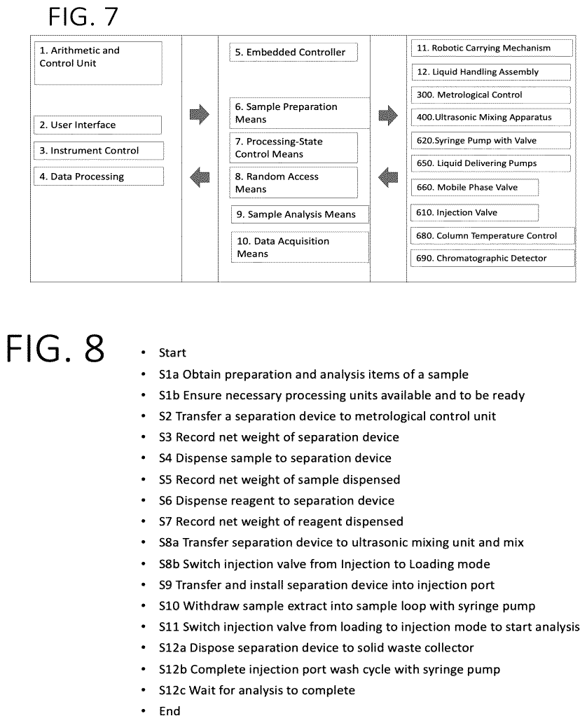

Next a control system of the sample preparation and analysis apparatus will be described with reference to FIG. 7. An embedded controller 5 controls operations of all processing units including robotic carrying mechanism 11, liquid handling assembly 12, metrological control 300, ultrasonic mixing apparatus 400, syringe pump with selection valve 620, liquid delivering pumps 650, 2-position four-port mobile phase valve 660, 2-position six-port injection valve 610, column temperature control 680 and chromatographic detector 690 which are included in the sample preparation and analysis apparatus. Each of the processing unit is configured to perform predetermined processing operations specified in a preparation item or an analysis item that contains one set of sample preparation or analysis operations corresponding to each unique assay. A preparation item needs units 11, 12, 300, 400, 620 and 610 to work sequentially or in sync at times to prepare and load a sample extract into the sample loop 611. An analysis item starts with a sample extract loaded in the sample loop and ends with liquid delivering pumps 650 finishing the time program (isocratic or gradient) while units 650, 660, 610, 680 and 690 working in sync with each other.

The controller 5 is implemented by an embedded single-board computer provided in the sample preparation and analysis apparatus, and software code executed by the embedded computer. The controller 5 is electrically connected with an arithmetic and control unit 1 implemented by a separate standalone computer, and an analyst controls the sample preparation and analysis apparatus by specifying a sample position, a sample preparation item and a sample analysis item via the user interface 2 running on the arithmetic and control unit 1.

The embedded controller 5 includes a preparation means 6, a processing-state control means 7, a random access means 8, a sample analysis means 9 and a data acquisition means 10. Each of those means is a function fulfilled by execution of software code by the embedded computer forming the controller 5. A plurality of sample containers is set in the sample setting location, samples contained in those sample containers are processed sequentially one at a time according to priority set in advance, corresponding to the paired preparation and analysis item which should be executed on each sample. An analysis item can only start after a paired preparation item is completed.

The random access means 8 is configured to confirm a preparation or analysis item which should be executed next, either a different preparation and analysis item on same sample or same preparation and analysis item on next sample. Further, the random access means 8 is configured to start next confirmed preparation item so that ideally, next preparation item is performed and completed before current analysis item is completed, thus next analysis item can start as soon as current analysis item is completed. The random access means 8 is configured to poll a processing state in each processing unit and ensure the preparation means and sample analysis means are available when needed and ready for next processing item to be performed.

The processing-state control means 7 is configured to control availability of each unit and a process state in each unit. Availability of each unit can be controlled by tracking which unit is started with a processing operation and if the processing operation is completed by checking whether a time required to perform a processing operation elapses, or a signal indicating a processing operation is finished is received from the processing unit. For example, in case the time needed for a separation device 100 to be transported to a dispensation port 200 is known, the availability of the robotic arm can be tracked by the start and stop time, or by a state signal indicating if the robotic arm is moving or not.

An example of a preparation and analysis item consisting of a series of processing operations for one sample will be described with reference to the flowchart of FIG. 8 together with FIG. 6.

First, an analyst starts the process by specifying a preparation item and an analysis item to be performed on a sample and the sample position in a sample setting location for storing sample containers each containing a sample to be analyzed (step S1a). Right away, the availability of all necessary processing units is checked to ensure any unit to be ready at the time point when the unit will be needed (step S1b). For example, in a case where liquid delivering pumps 650 are not delivering flow at this point, the liquid delivering pumps needs to start flow, prime the fluidic system and fully condition the analytical column in order to get ready for sample analysis according to the specified analysis item. It will take some time for the fluidic system to reach a steady state and be ready, however, the preparation item can be started without waiting since the fluidic system only needs to be ready before a sample extract is loaded into the sample loop 611 according to the specified preparation item.

Next, the robotic arm transports an unused separation device 100 from a separation device setting location to the dispensation port 302 on top of the metrological control unit 300 that has been tared to zero in advance (step S2). The weight of the separation device 100 is then measured and recorded (Step S3). The metrological control unit is then tared to zero and ready for the next measurement.

Next, a sampling device carried by a robotic arm takes a sample aliquot from the specified sample container in a sample setting location and dispenses into the separation device 100 held in the dispensation port 302 (step S4). The weight of the sample aliquot is measured and recorded before the metrological control unit is tared to zero again and ready for next measurement (step S5). In a similar way to Steps S4 and S5, an aliquot of reagent from a reagent container stored at a reagent sitting location and specified by the preparation item is dispensed into the separation device 100 (step S6) and the weight of the reagent aliquot is obtained (step S7). If specified by the preparation item, more reagents can be dispensed into the separation device by repeating steps S6 and S7. If the weight of sample or reagent aliquot is not within the targeted acceptable range specified in the preparation item, the process will abort and restart.

After sample and all reagents are added into the separation device, the robotic arm transports the separation device to the ultrasonic mixing apparatus 400 which apply ultrasonic power in multiple short pulses to the separation device to mix the content in the separation device (step S8a). Simultaneously, the injection valve 610 is switched from Injection to Loading mode so that the sample loop 611, the syringe pump 620 and the injection port 500 are connected and sample extract can be loaded into the sample loop 611 (step S8b). Again, the robotic arm transport and push the separation device into the injection port so that a Luer-type liquid-tight connection is formed between the separation device and the injection port (step S9). Then, the syringe pump withdraws the sample extract in the separation device into the sample loop (step S10). After the injection valve 610 switches from Loading to Injection mode, sample extract held in the sample loop 611 is injected into high pressure flow provided by the liquid delivery system 650 that runs predetermined isocratic or gradient time program (step S11). Signal from the detector 690 resulting from individual components separated by the analytical column 680 is acquired and stored for data analysis.

Once analysis starts following switching the injection valve from Loading to Injection mode, the robotic arm may dispose the separation device that is used to a solid waste collector (step S12a) and the syringe pump may complete the specified wash cycle of the injection port (step S12b). Thereafter, another preparation item can be started without waiting for current analysis to complete (step S12c).

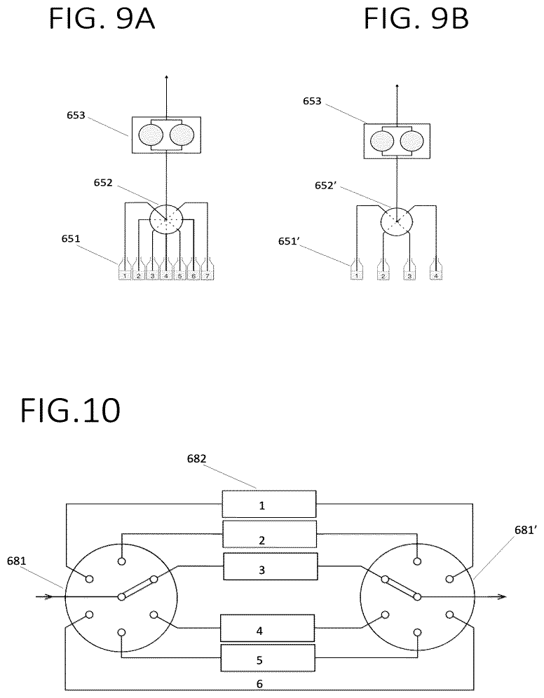

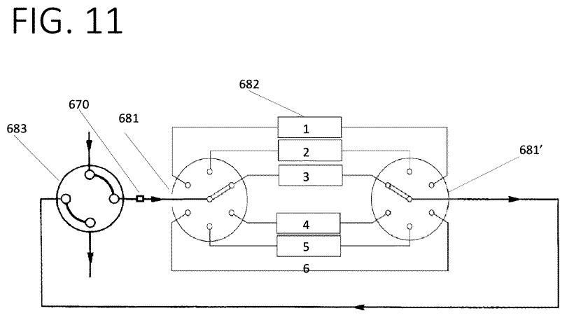

Described above, with regards to random access for a variety of different assays on a single system, a preparation item may include different separation devices with different separation layers, different numbers and types of reagents, multiple different types of cleaning fluid as well as different ultrasonic power and time intervals for mixing; for an analysis item, only isocratic or gradient, gradient time program, and different detectors are discussed. Next, examples of additional features of an analysis item that can greatly enhance the random-access capability will be described with references to FIG. 9A, FIG. 9B, FIG. 10 and FIG. 11.

A liquid delivery apparatus 650 in FIG. 6 can be a more sophisticated one shown in FIG. 9A or FIG. 9B as examples. Illustrated in FIG. 9A, a 7-position and 8-port valve 652 can be used as a solvent selection device and provides a serial dual-piston pump 653 access to up to 7 different mobile phases 651. One mobile phase out of seven can be selected by controlling the selection valve according to a sample analysis item. A binary system with two such liquid delivery apparatus 650 can deliver up to forty nine combinations of binary mobile phases. Solvent selection valves with even more ports are available. Illustrated in FIG. 9B is a commonly called quaternary pump where a serial dual-piston pump 653 draws solvents from a four-port proportioning valve 652′. The pump's microprocessor controls the solvent composition of each intake piston stroke by the timed opening of each solvent port. Typically, solvent blending occurs inside the first piston cylinder and a mixer can also be installed right after the proportioning valve 652′. In this way, a mobile phase specified by a sample analysis item can be delivered by automatically blending up to four solvents 651′ in situ, with less mobile phase/solvent containers to manage.

In place of an analytical column 680 inside a column oven illustrated in FIG. 6, a fully automated column selection setup illustrated in FIG. 10 utilizes two identical 6-position 7-port valves 681 and 681′ that operates in sync so that an analytical column 682 from 1 to 5 or a bypass line 6 can be selected according to an analysis item. Analytical columns 682 from 1 to 5 may be temperature controlled independently, can be of different dimensions (length, internal dimeter, particle size, etc.), can be packed with different chromatographic sorbents. The bypass line 6 can be utilized for flow injection analysis as shown or a sixth analytical column. A column selection setup can be achieved with a single valve with appropriate ports and there are valves available which provides access to even more analytical columns. Further as illustrated in FIG. 11, an additional four-port valve 683, same as valve 660 described above, can be connected in such a way that the flow direction through the in-line mixing device 670 and the analytical column 682 can be reversed by switching valve 683. In this way, the analytical column 682 and the in-line mixing device 670 (especially in case an inline filter is used) can be washed much better during a wash step in reverse direction compared to forward direction wash while sample extract is injected, resulting in a more robust system with long lifetime of analytical column.

It is worthy of noting that the terminology “analytical column” has been used so far and below in order to simplify description of this invention. However, it is apparent that it can be substituted with “extraction column”, “solid phase extraction column”, etc. For example, when an extraction column, of short length typically, is used in place of an analytical column, the sample preparation and analysis system described can be easily converted to a two-dimensional or multidimensional liquid chromatography system with additional equipment readily available, by those skilled in the art.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

What is claimed is:

1. A fully automated sample preparation system, comprising:
a. a cylindrical separation device for receiving a biological fluid sample and reagents;
b. a robotic arm assembly with a carrying mechanism to perform a predefined holding task;
c. a liquid handling system having a sampling nozzle to obtain an aliquot of a sample or reagents for the separation device;
d. a metrological control device having a measurement system;
e. a mixing apparatus having an ultrasonic device for providing ultrasonic energy to mix and clean the sample, and
f. an injection system coupled to the separation device wherein an injection port connects a flow path in an automated sample analysis system.

2. The fully automated sample preparation system of claim 1 wherein the injection port connected to an injection system comprising:
a. a two-position injection valve;
b. a syringe pump to withdraw fluid from the separation device; and
c. a sample loop wherein the injection valve provides access to a binary pump system for automated sample analysis.

3. The fully automated sample preparation system of claim 1 wherein the robotic arm has a robotic gripper activated electronically or pneumatically.

4. The fully automated sample preparation system of claim 1 wherein the metrological control device records the weight of a biological sample or reagent in the separation device.

5. The fully automated sample preparation system of claim 4 wherein the metrological control device contains a dispensation port positioned as a load receptor for setting the separation device to measure a biological sample or reagent when dispensed into the separation device.

6. The fully automated sample preparation system of claim 5 wherein the metrological control device is capable of accurate measurements of approximately 1, 0.1 or 0.01 milligrams;

7. The fully automated sample preparation system of claim 1 wherein the mixing apparatus is selected from the group consisting of an ultrasonic probe, a shaker, a vortex mixer, and combinations thereof.

8. An integrated sample preparation and analysis system, comprising:
a. A sample preparation subsystem according to claim 1;
b. A sample analysis subsystem; and
c. A control subsystem,
wherein a standalone computer with software controls the integration of sample preparation and analysis.

9. The integrated sample preparation and analysis system of claim 8 wherein the sample analysis subsystem comprises:
a. two liquid delivering pumps for delivering mobile phases into an analytical flow path having a solvent selection valve to access different mobile phases;
b. a 2-position valve which connects with the liquid delivering pumps from downstream and selects the different mobile phases to flow through the sample loop of the injection valve; and
c. a static mixing device downstream of the injection valve to combine and mix the different mobile phase flows before entering an analytical column that is used to retain and separate one or more target components originated from the biological sample.

10. The integrated sample preparation and analysis system of claim 9 wherein the analytical column is a plurality of analytical columns available into an analytical flow path.

11. The integrated sample preparation and analysis system of claim 10 further having an optional 2-position valve to switch flow direction through an analytical column.

12. The integrated sample preparation and analysis system of claim 10 further having a detector which detects the target components separated in the analytical column.

13. The integrated sample preparation and analysis system of claim 8 wherein the control subsystem comprises:
a. a controller which controls operations of the sample preparation subsystem and the sample analysis subsystem to include a sample preparation configured to perform extraction with a separation device by filtration and load sample extraction into the sample loop;
b. a data structure that contains stored information pertaining to a plurality of unique assays including types of samples, a plurality of sample preparation items each of which includes a predefined set of preparation operations corresponding to one particular assay and a plurality of predefined sets of analysis operations corresponding to a particular assay; and
c. a user interface application, wherein an analyst can submit a test order by specifying a sample position and selecting a particular assay, in a random access way from a plurality of unique assays.

14. The integrated sample preparation and analysis system of claim 8 wherein the analysis subsystem is a clinical diagnostic system applied in the integration of the sample preparation.

15. The integrated sample preparation and analysis system of claim 14 wherein the sample preparation and analysis are multiple assays from a plurality of unique assays which can be selected to be performed on a sample.

16. The integrated sample preparation and analysis system of claim 15 wherein the multiple assays can be performed randomly in time.

17. The integrated sample preparation and analysis system of claim 16 wherein the multiple assays do not require calibrators to routinely establish a calibration curve for quantitative analysis.
